(19) United States
(12) Patent Application Publication
(10) Pub. No.: US 2026/0238107 A1
(43) Pub. Date: Aug. 13, 2026

(54) STEPPING MOTOR

(71) Applicant: AAC Microtech (Changzhou) Co., Ltd., Changzhou City (CN)

(72) Inventors: Lubin Mao, Changzhou (CN); Ze Fu, Changzhou (CN)

(21) Appl. No.: 19/292,968

(22) Filed: Aug. 7, 2025

Related U.S. Application Data
(63) Continuation of application No. PCT/CN2025/077212, filed on Feb. 13, 2025.

(51) Int. Cl. H02K 37/10; H02K 7/116; H02K 37/24

(52) U.S. Cl. CPC H02K 37/10; H02K 7/116; H02K 37/24

(57) ABSTRACT

A stepping motor includes two oppositely arranged clamping plates, a rotating shaft supported on the two clamping plates, magnetic steel fixed to the rotating shaft, and a stator unit disposed on the magnetic steel. The stator unit includes a stator arranged on the magnetic steel. The stator includes two claw poles sleeved over the rotating shaft, a first connection plate and a second connection plate respectively fixed to the two claw poles, and a solenoid fixed between the first connection plate and the second connection plate. The solenoid includes an iron core clamped between the first connection plate and the second connection plate, and a coil wound around the iron core. The stepping motor in the present invention can further reduce its width dimension to achieve an ultra-thin design, while converting the single-output form of the stepping motor into a dual-output shaft form.

### CROSS-REFERENCE TO RELATED APPLICATIONS

This application is a continuation of International Application No. PCT/CN2025/077212, filed on Feb. 13, 2025, the entire content of which is incorporated herein by reference.

### TECHNICAL FIELD

The present invention relates to the technical field of electric motors, in particular to a stepping motor.

### BACKGROUND

Stepper motors have been widely applied in fields such as electric motors and generators due to their advantages of high operational efficiency and energy-saving consumption reduction.

In the related art, stepper motors may be categorized into single-stator configurations and multi-stator configurations based on the number of stators. Such stepper motors with stator configurations include a rotating shaft, a magnetic steel fixed to the outer periphery of the rotating shaft, and stators sleeved over the rotating shaft and rotatably connected thereto. Each stator includes two claw poles and coils sleeved over the outer periphery of the claw poles.

In the above-described stepper motor with such stator configurations, the coil axis coincides with the motor axis. Consequently, the motor's width dimension perpendicular to its axis is constrained by the combined thickness of the magnetic steel, claw poles, and coils, making further size reduction challenging. Additionally, this stator configuration employs only a single rotating shaft, thus permitting just one operational output.

Therefore, there is a need for a novel stepping motor to address the aforementioned technical issues.

### SUMMARY

The object of the present invention is to provide a novel stepping motor to address the problems in the related art that stepping motors with stator configurations are difficult to further reduce in width dimension and can only provide a single output.

In order to overcome the shortcomings of the prior art, the present invention provides a stepping motor includes: two clamping plates disposed opposite to each other; a rotating shaft supported between the two clamping plates and rotatably connected to the clamping plates; a magnetic steel sleeved over and fixed to an outer periphery of the rotating shaft; and a stator unit spaced apart from a periphery of the magnetic steel and configured to drive the rotating shaft to rotate, the two clamping plates are spaced apart from the magnetic steel along an axial direction of the rotating shaft; the stator unit includes a stator spaced apart from the periphery of the magnetic steel; the stator includes: two claw poles spaced apart from each other along the axial direction of the rotating shaft; a first connection plate fixed to one of the claw poles; a second connection plate fixed to the other claw pole; and a solenoid sandwiched between the first connection plate and the second connection plate; the solenoid includes: an iron core sandwiched between the first connection plate and the second connection plate; and a coil wound on an outer periphery of the iron core and spaced apart from the claw poles. A winding direction of the coil is parallel to the axial direction of the rotating shaft; the solenoid further includes a first solenoid and a second solenoid spaced apart along a radial direction of the rotating shaft and disposed on opposite sides of the claw poles respectively; the stepping motor further includes: an output gear sleeved over and fixed to an output end of the rotating shaft; two first rotating shafts supported on one of the clamping plates and rotatably connected thereto; and two transmission gears sleeved over and fixed to the two first rotating shafts and in mesh with the output gear. The two transmission gears are disposed on opposite sides of the output gear along the radial direction of the rotating shaft.

Preferably, the stator unit includes a plurality of the stators stacked sequentially along the axial direction of the rotating shaft; the coils of the first solenoids of the plurality of stators are arranged coaxially, and the coils of the second solenoids of the plurality of stators are arranged coaxially. The fixing portion of the claw pole adjacent to the clamping plate is fixedly connected to the clamping plate.

Preferably, the two transmission gears are respectively disposed opposite to the first solenoid and the second solenoid along the axial direction of the rotating shaft.

Preferably, each of the transmission gears includes a first gear meshing with the output gear; and a second gear protruding and extending from a central portion of the first gear away from the clamping plate.

Preferably, the two coils of the same stator have identical or opposite current directions; the coils of the adjacent stators have opposite energizing directions.

Preferably, both the first connection plate and the second connection plate of the same stator are integrally formed with the iron core.

Preferably, each claw pole includes: an annular fixing portion; and a plurality of claw teeth extending from an inner periphery of the fixing portion along the axial direction of the rotating shaft, the claw teeth are spaced apart; for the same stator: the claw teeth of one claw pole extend toward the other claw pole; the claw teeth of the two claw poles are interleaved; the first connection plate and the second connection plate are fixed to the fixing portions of the corresponding claw poles, respectively; and wherein for the adjacent stators: the fixing portions of two adjacent claw poles are fixedly connected; and the fixing portion of the claw pole adjacent to the clamping plate is fixedly connected to the clamping plate.

Preferably, the first connection plate of the same stator is integrally formed with the fixing portion of the corresponding claw pole; and the second connection plate of the same stator is integrally formed with the fixing portion of the corresponding claw pole.

Preferably, each of the claw teeth of one claw pole extends between two adjacent claw teeth of the other claw pole in the same stator.

Compared with related technologies, in the stepping motor of this embodiment, the first solenoid and the second solenoid of the solenoid are spaced apart from each other along the radial direction of the rotating shaft and disposed on opposite sides of the claw poles. This arrangement ensures that the axis of the coil in the solenoid does not coincide with the axis of the stepping motor. Correspondingly, the width dimension of the stepping motor perpendicular to its axial direction is no longer constrained by the thickness of the coil, thereby further reducing the width dimension and achieving the thinnest possible design for the stepping motor. Meanwhile, leveraging the reduced width dimension, the torque performance of the stepping motor can be further enhanced by adjusting the thickness of the coil. Furthermore, by adding two first rotating shafts to one of the clamping plates and engaging them with the output gear of the rotating shaft via the transmission gears, the single-output configuration of the stepping motor can be converted into a dual-output shaft configuration.

### BRIEF DESCRIPTION OF THE DRAWINGS

In order to explain the technical solutions of the embodiments of the present invention more clearly, the following will briefly introduce the accompanying drawings used in the embodiments. Apparently, the drawings in the following description are only some embodiments of the present invention. Those of ordinary skill in the art can obtain other drawings based on these drawings without creative work.

FIG. 1 is a perspective view of a stepping motor according to an embodiment of the present invention;

FIG. 2 is an exploded partial view of the stepping motor according to the embodiment of the present invention;

FIG. 3 is a cross-sectional view taken along line A-A in FIG. 1; and

FIG. 4 is a schematic diagram of magnetic poles and current directions of the stepping motor according to the embodiment of the present invention.

Reference numerals in the drawings denote as follows: 100, Stepping motor; 1, Clamping plate; 11, Bearing; 12, First bearing; 2, Rotating shaft; 3, Magnetic steel; 4, Stator; 41, Claw pole; 411, Fixing portion; 412, Claw teeth; 42, First connection plate; 43, Second connection plate; 44, Solenoid; 441, Iron core; 442, Coil; 44a, First solenoid; 44b, Second solenoid; 5, Output gear; 6, First rotating shaft; 7, Transmission gear; 71, First gear; 72, Second gear.

### DETAILED DESCRIPTION OF THE EMBODIMENTS

The technical solutions in the embodiments of the present invention will be clearly and completely described below in conjunction with the accompanying drawings in the embodiments of the present invention. Apparently, the described embodiments are only a part of the embodiments of the present invention, rather than all the embodiments. Based on the embodiments in the present invention, all other embodiments obtained by those ordinarily skilled in the art without doing creative work shall fall within the protection scope of the present invention.

### Embodiment 1

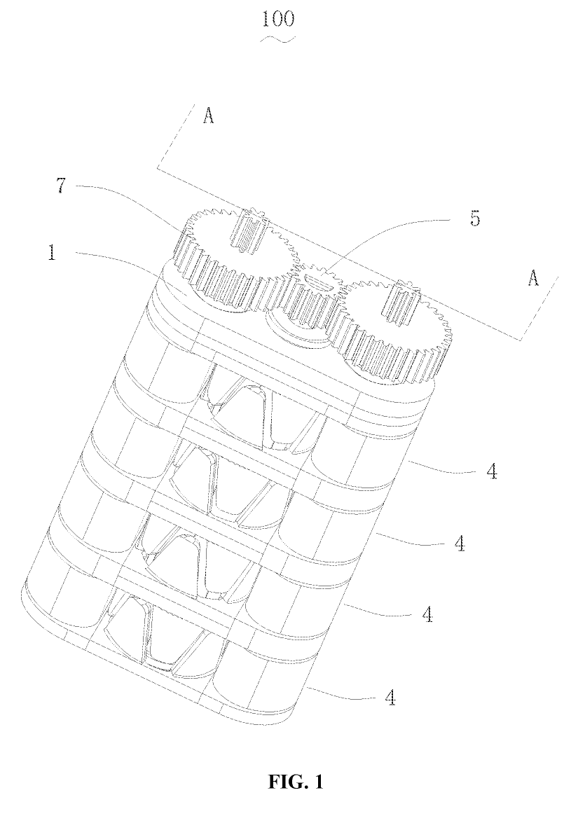

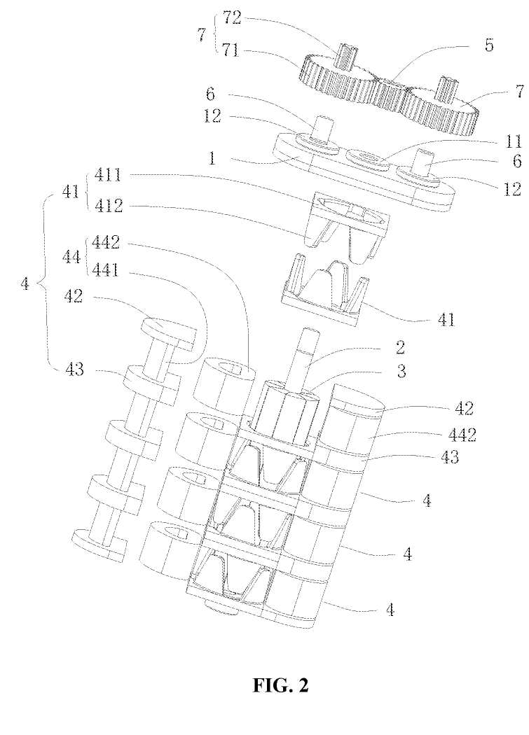

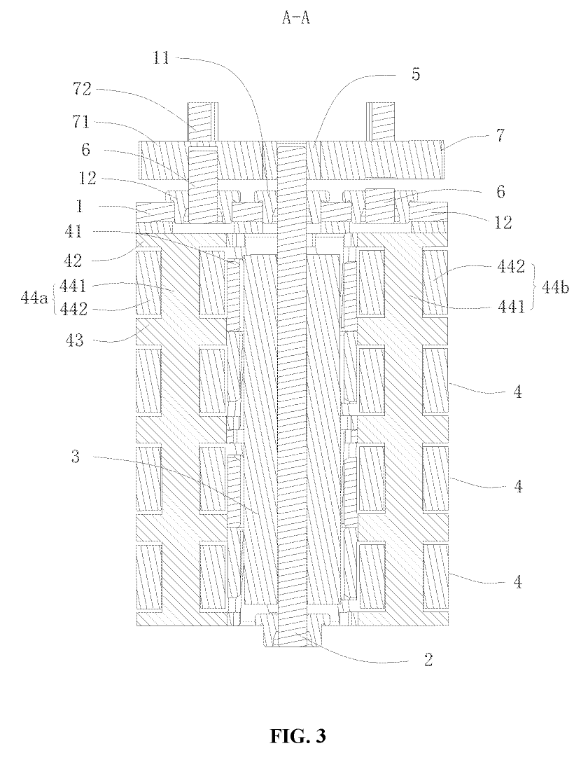

The embodiment of the present invention provides a stepping motor 100. As shown in FIGS. 1 to 3, the stepping motor includes two clamping plates 1 disposed opposite to each other, a rotating shaft 2 supported between the two clamping plates 1 and rotatably connected thereto, a magnetic steel 3 sleeved over and fixed to an outer peripheral side of the rotating shaft 2, and a stator unit spaced apart from a periphery of the magnetic steel 3 and configured to drive the rotating shaft 2 to rotate. The two clamping plates 1 are spaced apart from the magnetic steel 3 along an axial direction of the rotating shaft 2.

Each clamping plate 1 may be configured as either a single-layer clamping plate 1 or a stacked multi-layer clamping plate 1. In this embodiment, each clamping plate 1 adopts a double-layer configuration, with one such clamping plate 1 not shown in the drawings.

Each clamping plate 1 is fixedly embedded with a bearing 11. Both ends of the rotating shaft 2 are rotatably connected to the two clamping plates 1 via the two bearings 11.

The magnetic steel 3 may be configured as either a single annular magnetic steel 3 or a plurality of magnetic steel units. In the latter configuration, the plurality of magnetic steel units are arranged around the rotating shaft 2 and fixed to the outer periphery of the rotating shaft 2. In this embodiment, the magnetic steel 3 includes eight magnetic steel units.

Specifically, the stator unit includes a stator 4 spaced apart from a periphery of the magnetic steel 3. The stator 4 includes two claw poles 41 sleeved over the rotating shaft 2 and spaced apart from each other along an axial direction of the rotating shaft 2, a first connection plate 42 fixed to one of the claw poles 41, a second connection plate 43 fixed to the other claw pole 41, and a solenoid 44 sandwiched between the first connection plate 42 and the second connection plate 43.

The solenoid 44 includes an iron core 441 sandwiched between the first connection plate 42 and the second connection plate 43, and a coil 442 wound around an outer periphery of the iron core 441 and spaced apart from the claw poles 41. A winding direction of the coil 442 is parallel to the axial direction of the rotating shaft 2. The solenoid 44 further includes a first solenoid 44a and a second solenoid 44b spaced apart along a radial direction of the rotating shaft 2 and disposed on opposite sides of the claw poles, respectively.

Depending on application requirements, the stator unit may include one stator 4 or a plurality of stators 4. When the stator unit includes a plurality of stators 4, the plurality of stators 4 are sequentially stacked along the axial direction of the rotating shaft 2. The coils 442 of the first solenoids 44a of the plurality of stators 4 are coaxially arranged, and the coils 442 of the second solenoids 44b of the plurality of stators 4 are coaxially arranged.

In this embodiment, the stator unit includes four stators 4. Since the plurality of stators 4 are sequentially stacked along the axial direction of the rotating shaft 2, the claw poles 41 of one stator 4 are fixedly connected to the claw poles 41 of an adjacent stator 4, and the second connection plate 43 of one stator 4 is integrally formed with the first connection plate 42 of another adjacent stator 4. Certainly, the second connection plate 43 of one stator 4 and the first connection plate 42 of another adjacent stator 4 may alternatively not be integrally formed, provided that they are fixedly connected.

Each claw pole 41 includes an annular fixing portion 411 and a plurality of claw teeth 412 extending axially from an inner periphery of the fixing portion 411 along the rotating shaft 2, with the plurality of claw teeth 412 spaced apart. In the same stator 4, the claw teeth 412 of one claw pole 41 extend toward the other claw pole 41, and the claw teeth 412 of the two claw poles 41 are interleaved. The first connection plate 42 and the second connection plate 43 of the same stator 4 are fixed to the fixing portions 411 of the corresponding claw poles 41, respectively. In two adjacent stators 4, the fixing portions 411 of two adjacent claw poles 41 are fixedly connected, and the fixing portion 411 of the claw pole 41 adjacent to the clamping plate 1 is fixedly connected to the clamping plate 1. In this embodiment, each claw pole 41 includes four claw teeth 412.

In the same stator 4, each of the claw teeth 412 of one claw pole 41 extends between two adjacent claw teeth 412 of the other claw pole 41.

Both the first connection plate 42 and the second connection plate 43 of the same stator 4 are integrally formed with the iron core 441. This design enhances the stability of the connections between the first connection plate 42 and the iron core 441, as well as between the second connection plate 43 and the iron core 441.

The first connection plate 42 of the same stator 4 is fixedly connected to the fixing portion 411 of the corresponding claw pole 41; the second connection plate 43 of the same stator 4 is fixedly connected to the fixing portion 411 of the corresponding claw pole 41.

Since the solenoid 44 includes the first solenoid 44a and the second solenoid 44b disposed on opposite sides of the claw poles 41, respectively, the same stator 4 includes two first connection plates 42 and two second connection plates 43, which are fixed to opposite sides of the corresponding claw poles 41, respectively. Correspondingly, one first connection plate 42 and one second connection plate 43 are integrally formed with the iron core 441 of the first solenoid 44a, while the other first connection plate 42 and the other second connection plate 43 are integrally formed with the iron core 441 of the second solenoid 44b.

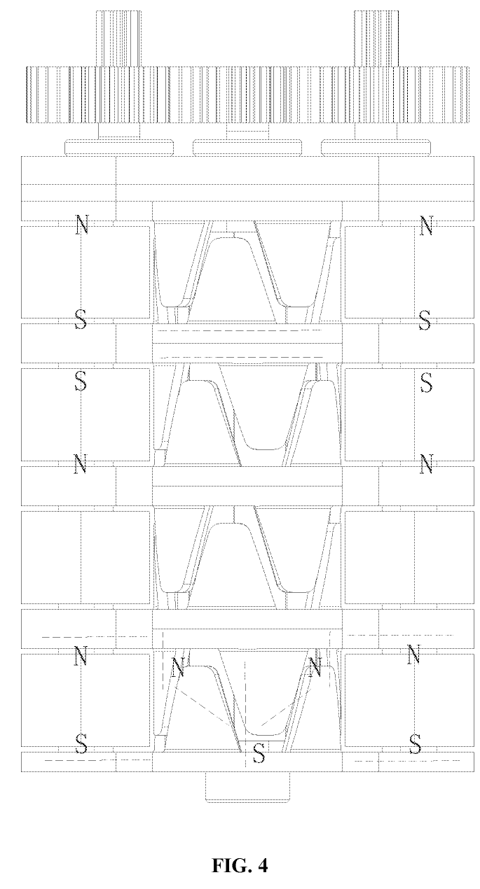

In the same stator 4, the two coils 442 have the same current direction, and the coils 442 of adjacent stators 4 have opposite energizing directions, as shown in FIG. 4. Certainly, the current directions of the two coils 442 in the same stator 4 may also be opposite. In this case, the magnetic poles generated by the solenoid 44 are opposite, which can prevent the electromagnetic field of the stator 4 from being prone to magnetic short-circuiting.

When the coils 442 of the first solenoid 44a and the second solenoid 44b in each stator 4 are energized, the two polarized ends of the first solenoid 44a and the second solenoid 44b exhibit opposite magnetic poles. The same ends of the first solenoid 44a and the second solenoid 44b after polarization have the same magnetic poles, which polarize the claw poles 41 at the same ends. Specifically, when energized, the coils 442 cause the first solenoid 44a and the second solenoid 44b to polarize into N and S poles at their respective ends. The same ends of the two solenoids exhibit identical magnetic poles, thereby polarizing the adjacent claw poles 41 to match. Consequently, the claw pole 41 adjacent to the N pole of the solenoid 44 becomes an N pole, and the claw pole 41 adjacent to the S pole becomes an S pole, as shown in FIG. 4.

When the coils 442 of the first solenoid 44a and the second solenoid 44b in each stator 4 are energized with alternating current, the magnetic poles of the two claw poles 41 both alternate, where the claw poles 41 alternate between N poles and S poles, thereby enabling rotation of the stepping motor 100.

Specifically, the stepping motor 100 further includes an output gear 5 sleeved over and fixed to an output end of the rotating shaft 2, two first rotating shafts 6 supported on one of the clamping plates 1 and rotatably connected thereto, and two transmission gears 7 sleeved over and fixed to the two first rotating shafts 6 and meshing with the output gear 5, respectively. The two transmission gears 7 are disposed on opposite sides of the output gear 5 along the radial direction of the rotating shaft 2.

The radial directions of the two first rotating shafts 6 are respectively parallel to a radial direction of the rotating shaft 2.

Each transmission gear 7 has a diameter smaller than a width of the corresponding clamping plate 1. This design ensures that the added two transmission gears 7 do not increase the width dimension of the stepping motor 100.

The two transmission gears 7 are respectively disposed opposite to the first solenoid 44a and the second solenoid 44b along the axial direction of the rotating shaft 2. This design further ensures that the supplemental two transmission gears 7 do not increase the width dimension of the stepping motor 100.

The transmission gear 7 includes a first gear 71 meshing with the output gear 5 and a second gear 72 protruding and extending from a central portion of the first gear 71 away from the clamping plate 1. This design enables a more stable connection between the transmission gear 7 and the driven equipment.

One end of the rotating shaft 2 is a semi-circular end, and the output gear 5 is fixed to the semi-circular end. This design enables the output gear 5 to be more stably fixed to the rotating shaft 2. One end of the first rotating shaft 6 is a first semi-circular end, and the first gear 71 is fixed to the first semi-circular end. This design enables the transmission gear 7 to be more stably fixed to the first rotating shaft 6.

One of the clamping plates 1 is embedded and fixed with two spaced apart first bearings 12, and the two first rotating shafts 6 are rotatably connected to the clamping plate 1 via the two first bearings 12, respectively. Correspondingly, one first rotating shaft 6 is rotatably connected to the clamping plate 1 via a corresponding first bearing 12.

Compared with related technologies, in the stepping motor 100 of this embodiment, the first solenoid 44a and the second solenoid 44b of the solenoid 44 are spaced apart from each other along the radial direction of the rotating shaft 2 and disposed on opposite sides of the claw poles 41. Additionally, the axes of the coils 442 disposed axially opposite to each other along the rotating shaft 2 in each stator 4 are aligned. This arrangement ensures that the axis of the coil 442 in the solenoid 44 does not coincide with the axis of the stepping motor 100. Correspondingly, the width dimension of the stepping motor 100 perpendicular to its axial direction is no longer constrained by the thickness of the coil 442, thereby further reducing the width dimension and achieving the thinnest possible design for the stepping motor 100. Meanwhile, leveraging the reduced width dimension, the torque performance of the stepping motor 100 can be further enhanced by adjusting the thickness of the coil 442. Furthermore, by adding two first rotating shafts 6 to one of the clamping plates 1 and engaging them with the output gear 5 of the rotating shaft 2 via the transmission gears 7, the single-output configuration of the stepping motor 100 can be converted into a dual-output shaft configuration.

### Embodiment 2

This embodiment differs from the Embodiment 1 in that the first connection plate 42 of the same stator 4 is integrally formed with the fixing portion 411 of the corresponding claw pole 41, and the second connection plate 43 of the same stator 4 is integrally formed with the fixing portion 411 of the corresponding claw pole 41. This design enhances the stability of the connection between the first connection plate 42 and the corresponding claw pole 41, as well as between the second connection plate 43 and the corresponding claw pole 41.

Since the solenoid 44 includes a first solenoid 44a and a second solenoid 44b disposed on opposite sides of the claw pole 41, the same stator 4 includes two first connection plates 42 and two second connection plates 43. Correspondingly, each of the two first connection plates 42 is integrally formed with the fixing portion 411 of the corresponding claw pole 41, and each of the two second connection plates 43 is integrally formed with the fixing portion 411 of the corresponding claw pole 41.

As described above, one or more embodiments are provided in conjunction with the detailed description, The specific implementation of the present invention is not confirmed to be limited to that the description is similar to or similar to the method, the structure and the like of the present invention, or a plurality of technical deductions or substitutions are made on the premise of the conception of the present invention to be regarded as the protection of the present invention.

What is claimed is:

1. A stepping motor comprising:
two clamping plates disposed opposite to each other;
a rotating shaft supported between the two clamping plates and rotatably connected to the clamping plates;
a magnetic steel sleeved over and fixed to an outer periphery of the rotating shaft; and
a stator unit spaced apart from a periphery of the magnetic steel and configured to drive the rotating shaft to rotate,
wherein the two clamping plates are spaced apart from the magnetic steel along an axial direction of the rotating shaft;
the stator unit comprises a stator spaced apart from the periphery of the magnetic steel;
wherein the stator comprises:
two claw poles spaced apart from each other along the axial direction of the rotating shaft; a first connection plate fixed to one of the claw poles;
a second connection plate fixed to the other claw pole; and
a solenoid sandwiched between the first connection plate and the second connection plate; the solenoid comprises:
an iron core sandwiched between the first connection plate and the second connection plate;
and
a coil wound on an outer periphery of the iron core and spaced apart from the claw poles,
wherein a winding direction of the coil is parallel to the axial direction of the rotating shaft;
the solenoid further comprises a first solenoid and a second solenoid spaced apart along a radial direction of the rotating shaft and disposed on opposite sides of the claw poles respectively;
the stepping motor further comprises:
an output gear sleeved over and fixed to an output end of the rotating shaft;
two first rotating shafts supported on one of the clamping plates and rotatably connected thereto; and
two transmission gears sleeved over and fixed to the two first rotating shafts and in mesh with the output gear,
wherein the two transmission gears are disposed on opposite sides of the output gear along the radial direction of the rotating shaft.

2. The stepping motor according to claim 1, wherein the stator unit comprises a plurality of the stators stacked sequentially along the axial direction of the rotating shaft; the coils of the first solenoids of the plurality of stators are arranged coaxially, and the coils of the second solenoids of the plurality of stators are arranged coaxially.

3. The stepping motor according to claim 1, wherein the two transmission gears are respectively disposed opposite to the first solenoid and the second solenoid along the axial direction of the rotating shaft.

4. The stepping motor according to claim 1, wherein each of the transmission gears comprises a first gear meshing with the output gear; and a second gear protruding and extending from a central portion of the first gear away from the clamping plate.

5. The stepping motor according to claim 2, wherein the two coils of the same stator have identical or opposite current directions; the coils of the adjacent stators have opposite energizing directions.

6. The stepping motor according to claim 2, wherein both the first connection plate and the second connection plate of the same stator are integrally formed with the iron core.

7. The stepping motor according to claim 2, wherein each claw pole comprises:
an annular fixing portion; and
a plurality of claw teeth extending from an inner periphery of the fixing portion along the axial direction of the rotating shaft, wherein the claw teeth are spaced apart;
wherein for the same stator:
the claw teeth of one claw pole extend toward the other claw pole;
the claw teeth of the two claw poles are interleaved;
the first connection plate and the second connection plate are fixed to the fixing portions of the corresponding claw poles, respectively;
and wherein for the adjacent stators:
the fixing portions of two adjacent claw poles are fixedly connected; and
the fixing portion of the claw pole adjacent to the clamping plate is fixedly connected to the clamping plate.

8. The stepping motor according to claim 7, wherein:
the first connection plate of the same stator is integrally formed with the fixing portion of the corresponding claw pole; and
the second connection plate of the same stator is integrally formed with the fixing portion of the corresponding claw pole.

9. The stepping motor according to claim 7, wherein each of the claw teeth of one claw pole extends between two adjacent claw teeth of the other claw pole in the same stator.
